(19) United States
(12) Patent Application Publication
(10) Pub. No.: US 2016/0073061 A1
(43) Pub. Date: Mar. 10, 2016

(54) Vehicle Documentation System

(71) Applicant: ADESA, INC., Carmel, IN (US)

(72) Inventor: Christopher Dillow, Carmel, IN (US)

(21) Appl. No.: 14/477,615

(22) Filed: Sep. 4, 2014

(51) Int. Cl. H04N 7/18; H04N 5/225; H04N 1/00; G06Q 30/08

(52) U.S. Cl. CPC H04N 7/183; G06Q 30/08; H04N 5/2256; H04N 1/00244

(57) ABSTRACT

A distributed vehicle documentation system uses multiple sensor systems to capture vehicle information and generate vehicle documentation. A sensor system may be a micro server in communication with a sensor and a control device. In response to requests from the control device, the sensor system may measure and or adjust settings, such as light settings, dynamically within an enclosed area surrounding a vehicle. The settings may be predefined parameters based on a category of the vehicle. The sensor system may convert and transmit low resolution information to the control device for verification. In addition, the sensor system may transmit high resolution information to a storage device. The captured information by the sensor system in conjunction with other information of the vehicle may be combined to generate vehicle documentation of the vehicle with consistent image framing irrespective of size of the vehicle.

### TECHNICAL FIELD

This disclosure relates to a vehicle documentation system that uses multiple sensor systems to capture vehicle information and generate vehicle documentation.

### BACKGROUND

With rapid advances in network connectivity, the landscape for sale of items at auctions, such as sale of vehicles at auctions has also changed. For example, in the past, potential bidders at vehicle auctions physically inspected a vehicle prior to valuating the vehicle and determining whether to place a bid and/or what bid to place for the vehicle. More recently, potential bidders have adopted reviewing information about the auction-items electronically, such as through a website, over the Internet or other network connection having computer or other display equipment. For example, potential bidders on a vehicle may review documentation, including mechanical details, history, accident reports, and other information along with images of the vehicle. Improvements to providing electronic documentation will facilitate further adoption of electronic review and bidding.

### BRIEF DESCRIPTION OF THE DRAWINGS

FIG. 1 shows an example vehicle documentation system.

FIG. 2 shows an example booth controller device.

FIG. 3 shows an example sensor system.

FIG. 4 shows example method performed by a sensor system in a vehicle documentation system.

FIG. 5 shows example commands transmitted in a vehicle documentation system.

FIG. 6 shows an example vehicle documentation booth.

FIG. 7 shows an example vehicle documentation generation method.

### DETAILED DESCRIPTION

The discussion below makes reference to vehicle documentation booth to capture sensor data, such as images, of a vehicle. The vehicle documentation booth may be used for any documentation purpose, and may be particularly geared towards capturing images used in marketing, sales, or auction material for a vehicle. The vehicle documentation booth may be equipped with multiple sensor systems distributed within the booth structure, such as light-intensity sensors, vehicle position sensors, cameras, and dimmable lights. The sensors, lights, and other aspects of the vehicle documentation booth may be controlled by a control device, such as a handheld tablet computer, smartphone, desktop computer and any other such device. The control device may receive data from the sensor systems and in response may send instructions to some or all sensor systems in the booth.

For example, the control device may adjust intensity of the lights, request a particular camera to capture an image of the vehicle, store a captured image at a particular location on a storage device, and may populate a website with information associated with the vehicle. The control device may be equipped with sensor systems of its own. For example, the control device may be equipped with a camera that may be used to capture additional images of the vehicle, such as interior images of the vehicle. The images captured by the multiple cameras and the control device may be compiled together to create a collection of images used for marketing material for the vehicle. The control device may use a unique identifier of the vehicle, such as a Vehicle Identification Number (VIN) of the vehicle to associate the captured images and other information for future use with the vehicle documentation.

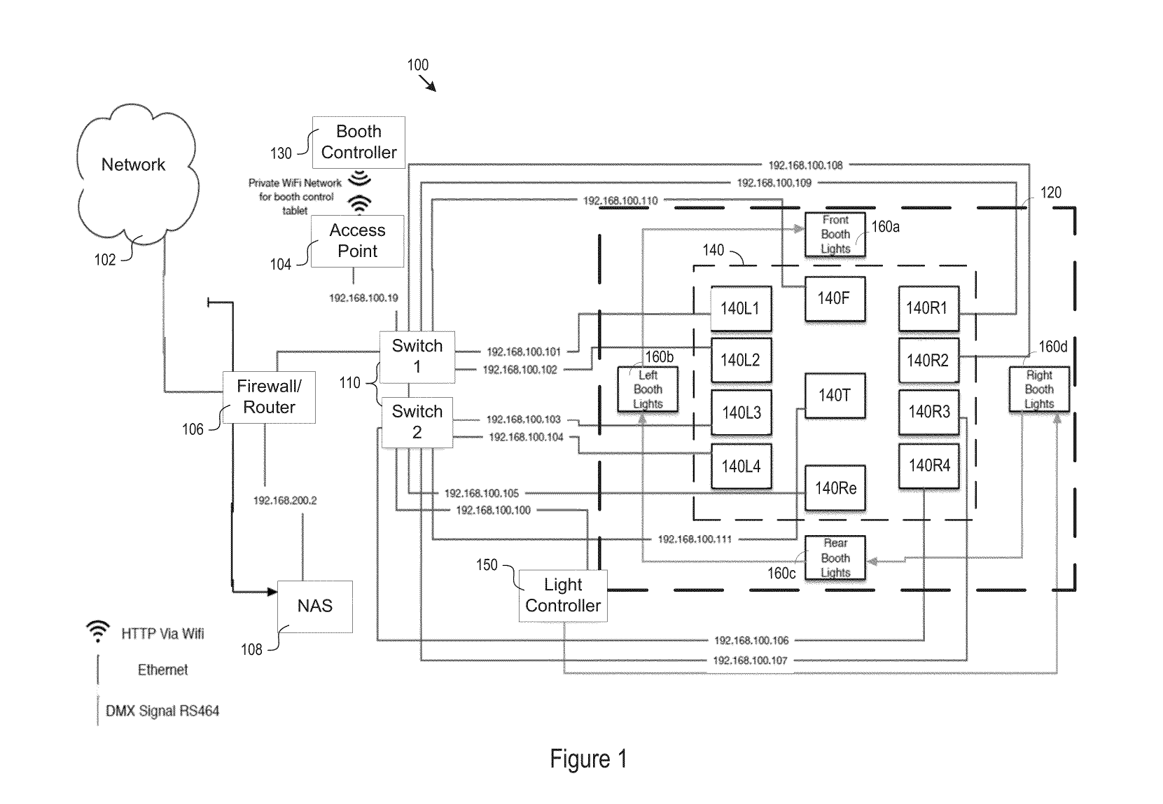

FIG. 1 shows an example vehicle documentation system 100. The system 100 may include several network devices which interface with a network 102. The network devices may include an access point 104, a firewall/router device 106, a network attached storage device 108, and network switches 110. The system 100 may further include a vehicle documentation booth 120, a vehicle documentation booth controller device 130, multiple sensor systems 140, a light controller 150, and several lights 160a-d. The vehicle documentation system 100 may include other devices than those noted above.

The structure of the vehicle documentation booth 120 may be designed to be installed and withstand any selected environmental conditions where it is used, such as the conditions in place at a car dealership, storage lot, auction facility, or other location. As one example, the vehicle documentation booth 120 may be built from abrasion-proof material, such as Extruded T-Slot Aluminum. The design may be modular to facilitate shipment of the booth 120 as a prefabbed kit to the documentation site. The booth structure may provide mounting points for the sensor system 140 and lights 160 and a controlled environment for consistent capture of sensor system measurements.

The lights 160a-d may be single lights or groups of lights that are placed at predetermined locations within the vehicle documentation booth 120 to serve as illumination sources. The lights may be controllable lights that provide a varying illumination output, such as 30,000 Lumen Daylight Balanced Studio Photography LED Lights. The lights may be Digital Multiplex (DMX) controlled allowing on/off and dimming capability for each light. The booth 120 may include multiple lights at any predetermined locations. For example, the booth may include 16 lights, in controllable groups of four lights each at the locations indicated in FIG. 1: front booth lights 160a, left booth lights 160b, rear booth lights 160c and right booth lights 160d. The lights 160a, 160b, 160c, and 160d may be located to the front, left, rear, and right of a vehicle positioned within the booth 120. However, lights may be placed individually or in groups in any pre-determined locations within the booth 120 to facilitate capture of an image of the vehicle from a particular position. A controlled group of lights may be defined to include any selection of the individual lights. For example, two of the lights on the right, two from the left and one from the rear may be included in a group of lights when capturing an image using a camera positioned at the front of the vehicle documentation booth 120. Other groups of lights may also be configured.

Each group of lights 160a-d may include one or more lights. The intensity of a group as a whole or each individual light within the group may be adjusted. The intensity may be adjusted via commands from the booth controller 130, or the sensor systems 140 using a DMX protocol such as DMX512. Alternatively, or in addition, the DMX512 protocol commands to the lights 160 may be bridged to the booth network via a custom written web service that runs on one of the sensor systems 140.

The network 102 may be a local area network, a wide area network, or any other network that enables communication of data. The network 102 may include one or more devices that may interact with data captured and/or stored by the other components of the vehicle documentation system 100. For example, the network 102 may include a desktop computer, a laptop computer, or a mobile device such as a smart phone or tablet computer, that interacts with the data captured and/or stored by the other components of the vehicle documentation system 100. The data captured and/or stored by the other components of the vehicle documentation system 100 may be stored, for example, by the network attached storage device 108 or by the vehicle documentation booth controller device 130, or by any other device.

The network attached storage 108 may be a server device, such as a file server. The network attached storage 108 may include circuitry to store data in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. The storage medium in the network attached storage 108 may be setup to create large reliable data stores, for example by adopting a RAID standard such as RAID 2, RAID 5, or any other configuration. Alternatively, or in addition, the network attached storage 108 may be cloud data storage, provided by a third-party service provider, such as Amazon, Google, or any other data storage providers.

The firewall/router device 106 may involve circuitry and software to provide a network security system to control incoming and outgoing network traffic from the network 102 based on a rule set. The firewall/router may establish a barrier between the network 102 and what may be considered an internal network of the vehicle documentation system 100. The internal network may include the components communicable via the network created by the network access point 104. For example, the internal network may include vehicle documentation booth 120, the vehicle documentation booth controller device 130, the sensor systems 140, the light controller 150, the switch 110, and the network attached storage 108. The internal network may be, for example, a local area network such as an Ethernet network, and may involve wired or wireless communication. The access point 104 may be a wireless access point. The internal network may further include network devices such as switches 110, routers, and hubs to extend the internal network and provide the devices within the internal network a medium to communicate. The network devices may be enabled to provide Power over Ethernet (PoE), for example, the switches may be PoE switches.

The internal network enables the vehicle documentation booth controller device 130 to transmit and receive data to and from the other devices such as the sensor systems 140 and light controller 150. The vehicle documentation booth controller device 130, also referred to as a booth controller device 130, may transmit and receive data such as network request/response and light controller request/response. The network request/response may be a web service request/response, such as using hyper-text transfer protocol (HTTP), or any other network communication protocol. The light controller request/response may use protocols such as digital multiplex (DMX) to control the lights 160a-d via the light controller 150.

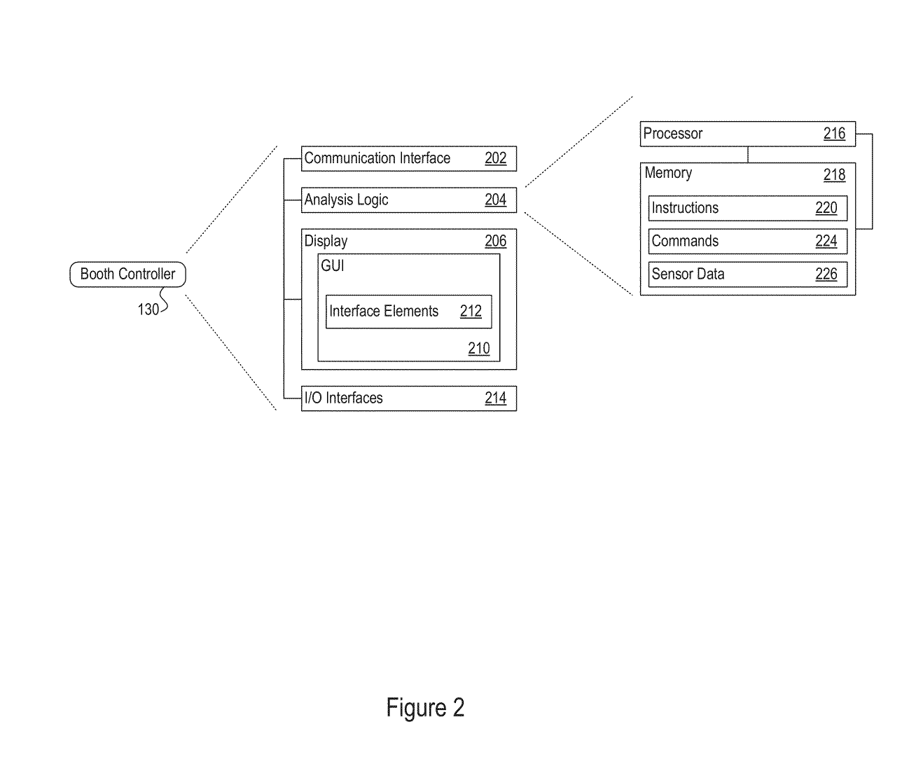

FIG. 2 shows an example booth controller device 130. The booth controller device 130 includes a communication interface 202, analysis logic 204, and a user interface 206. The communication interface 202 may include Universal Serial Bus (USB) interfaces, audio outputs, magnetic or optical media interfaces (e.g., a CDROM or DVD drive), network (e.g., Ethernet or cable (e.g., DOCSIS) interfaces), Serial Advanced Technology Attachment (SATA), and Peripheral Component Interconnect express (PCIe) interfaces and connectors, memory card slots or other types of serial, parallel, or network data interfaces. The communication interface 202 may include one or more Ethernet ports, or any other type of wired or wireless communication interface. For example, the communication interface 202 may include a communication interface for bi-directional communication of instructions/commands/data with the sensor systems 140, and light controller 150.

The user interface 206 may display, for example, a graphical user interface 210. The user interface 206 may display and accept user parameters, annotation commands, and display on the GUI 210 any type of vehicle documentation interface element 212. The interface element 212 may visualize, as just a few examples, images, light intensity level, or any other information or measurements captured by the sensor systems 140. The interface element 212 may also be directive interface element, such as a button, hyperlink, or any other interface element to provide a command or instruction to the system 100. For example, the interface element 212 may be an archival directive interface element that instructs one or more of the sensor systems 140 with an archival command to store captured information in the NAS 108. The user interface 206 may further present the information captured by the sensor systems 140 as an aggregated information portal, such as a web page. The captured information may be annotated with further information received from the NAS 108 or network 102, which the analysis logic 204 may request.

The input/output (I/O) interfaces 214 provide keyboard, mouse, voice recognition, touchscreen, and any other type of input mechanisms for operator interaction with the booth controller 130. Additional examples of the I/O interfaces 214 include microphones, video and still image cameras, temperature sensors, vibration sensors, rotation and orientation sensors, radiation sensors (e.g., IR or RF sensors), and other types of inputs.

The analysis logic 204 may include circuitry and software. In one implementation, the analysis logic 204 includes one or more processors 216 and memories 218. The memory 218 may store analysis instructions 220 (e.g., program instructions) for execution by the processor 216. The analysis logic 204 may include an application customized for mobile devices and operating systems, such as for Android, iOS, WebOS, Blackberry, or any other mobile device. This may allow any mobile device with the mobile application installed to effectively control the vehicle documentation system. The memory 218 may also hold the information received at the communication interface 202, such as sensor data 226 captured by the sensor systems 140. As will be described in more detail below, the analysis instructions may generate commands 224. The booth controller 130 may send the commands 224 to any network device whether within or external to the internal network. The commands 224, also referred to as requests, may cause the sensor systems 140 to be configured, capture information, store captured information, and transmit captured information to the booth controller device 130. The commands 224, in addition, or alternatively, may cause the lights 160a-d change intensity. Further, the commands 224 may change the way that a network device operates, request further annotation information from the network device, or cause any other adaptation. Some examples are described further below.

The booth controller device 130 may generate commands to control operation of the sensor systems 140. In an example, as in the example system 100, the sensor systems 140 may include multiple sensor systems 140F, 140T, 140Re, 140L1-L4 and 140R1-R4. Other examples may include more or less sensor systems. The sensor systems 140 may be distributed across the vehicle documentation booth 120. The sensor systems may be placed at predetermined locations within the vehicle documentation booth 120. For example, the 140T sensor system, in the example system 100 may be located on a roof of the vehicle documentation booth 120 directed or oriented so as to capture sensory information of the vehicle. For example, the sensor system 140T may include a camera pointed towards the floor of the vehicle documentation booth 120 so as to capture an image of a vehicle in the vehicle documentation booth 120. Similarly, the sensor system 140F may be located at the front, 140Re at the rear, 140L1-L4 at the left and 140R1-R4 at right so as to capture information from the vehicle within the vehicle documentation booth 120. The sensor systems 140 are placed at predetermined locations within the vehicle documentation booth so as to capture information of the vehicle from various possible angles and orientations. Alternatively, the sensor systems 140 may be movable in response to commands 224 from the controller device 130. The sensor systems 140 may be translated or rotated in one, two and/or three dimensions using servo motors, gears, extending jack plates, conveyors, or any other such movable mechanical elements.

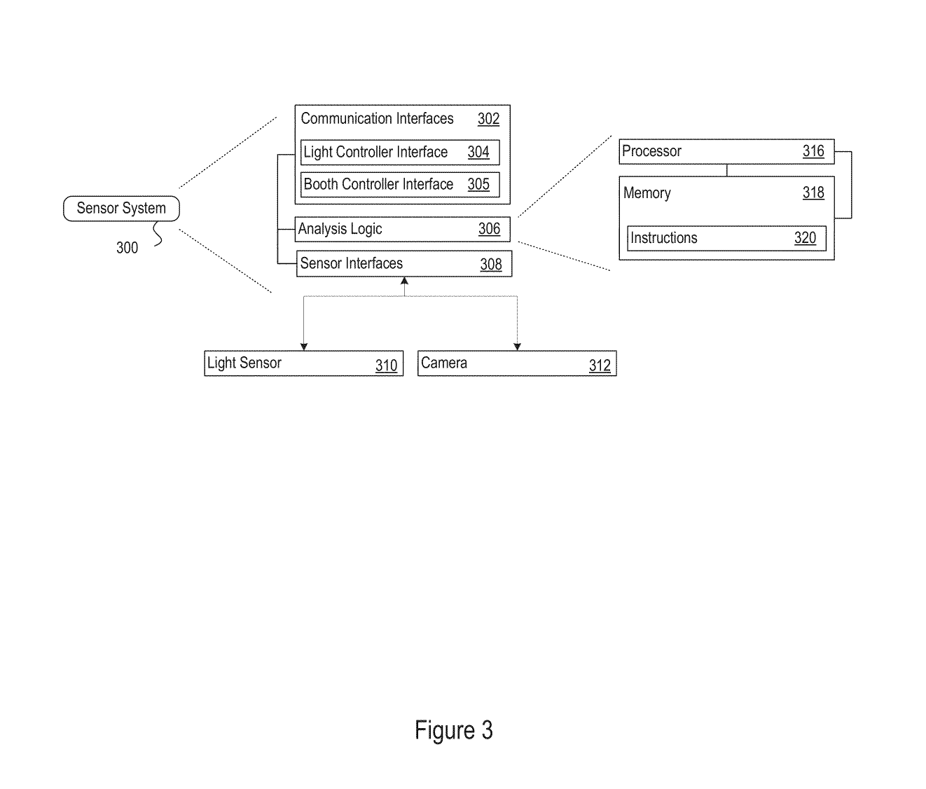

FIG. 3 shows an example sensor system 300. The sensor system 300 may be any one of the sensor systems 140. The sensor system 300 may include, among other components, communication interfaces 302, analysis logic 306, and sensor interfaces 308. The sensor system 300 may be a webserver that receives requests for data from the other network devices in the vehicle documentation system 100. The sensor system 300 may, in response, acquire the requested data and transmit it back to the requesting device. The request and response communication may occur over wired or wireless communication. The communication may use protocols such as HTTP, secure HTTP (HTTPS) or any other format.

The examples above refer to cameras in the sensor systems for capturing images. However, any sensor system may include sensors of any type. For instance, a sensor system may include an audio sensor, e.g., a microphone, a video capture device, a thermal sensor, a vibration sensor, an infrared sensor, exhaust sensors, or a sensor for any other type of measurement. Accordingly, the booth 120 may capture sensor data for the vehicle across a wide variety of environmental characteristics to facilitate obtaining data to characterize the vehicle in many different ways, e.g., engine noise, or exhaust temperature and chemical composition.

For example, instead of using cameras controlled via the booth controller 130 as a central computer, the system 100 may implement a distributed architecture in which sensors, e.g., cameras, are included as part of any sensor system 300. The sensor system 300 may further include a computer system, such as a micro server, that receives instructions to capture an image from the booth controller 130. When a central computer directly communicates with the sensors, each sensor may transfer a captured image to the central computer via a protocol such as USB or 802.11 a/b/g/n/ac or the like.

In contrast, in the distributed architecture, each camera may be communicated with via a micro server. The distributed architecture facilitates control and coordination of a large collection of sensors via lightweight scripts such as Hyper Text Markup Language (HTML), JavaScript, and other combinations of scripting languages. For example, the sensor system may be a custom programmed all in one system on a chip board, such as a Raspberry PI, HummingBoard, Banana Pi, or any other system on a chip. The sensor system may operate using an operating system such as Linux, Odroid, Android, Windows RT, or any other operating system. The sensor system may be enclosed in a rugged case, such an aluminum case, to withstand the environmental conditions within the documentation booth 120. Each sensor system may be implemented as a web server, which responds to requests for images, such as web service protocol requests, or web service requests, such as HTTP requests. Instead of providing images that are stored in response to an HTTP request for an image, the sensor system may capture images using the equipped sensor, and transmit the captured image to the storage device. In addition, or alternatively, the sensor system may transmit a copy of a captured image to the requesting device. The response may be compliant with the web service request/response protocol.

FIG. 3 shows one example implementation of the sensor system 300. The communication interfaces 302 may include Universal Serial Bus (USB) interfaces, audio outputs, magnetic or optical media interfaces (e.g., a CDROM or DVD drive), network (e.g., Ethernet or cable (e.g., DOCSIS) interfaces), Serial Advanced Technology Attachment (SATA), and Peripheral Component Interconnect express (PCIe) interfaces and connectors, memory card slots or other types of serial, parallel, or network data interfaces. The communication interfaces 302 may include one or more Ethernet ports, or any other type of wired or wireless communication interface. For example, the communication interface may include a light controller interface 304 for bi-directional communication of instructions/commands/data with the light controller 150, and a booth controller interface 306 for bi-directional communication of instructions/commands/data with the booth controller 130.

The sensor interfaces 308 communicate with sensors that may be controlled by the sensor system 300. The sensors controlled by the sensor system 300 may be equipped to capture and/or measure sound, still image, video, vibration, heat, infrared light and various other physical conditions in the booth 120. Examples of the sensors include microphones, video and still image cameras, temperature sensors, vibration sensors, rotation and orientation sensors, radiation sensors (e.g., IR or RF sensors), and other types of sensors. FIG. 3 illustrates the sensor interfaces 308 capable to communicate with a light sensors 310 and camera 312 that may be controlled by the sensor system 300. For example, settings for the camera 312, such as orientation, zoom, pan, lens exposure level, macro mode, shutter time, may be controlled prior to using the camera to capture an image. Further, the intensity of the lights 160a-d in the vehicle documentation booth 120 may be controlled based on light intensity level measured by the light sensors.

The analysis logic 306 [?] may process the commands 224 received at the communication interfaces 302 using the analysis instructions 320. The analysis logic 304 may, in turn, command the sensors via the sensor interfaces according to the commands 224. The analysis logic 304 may include circuitry and software. In one implementation, the analysis logic 304 includes one or more processors 316 and memories 318. The memory 318 may store the analysis instructions 320 (e.g., program instructions) for execution by the processor 316. The memory 318 may also hold the information received at the communication interface 302, and information captured at the sensor interfaces 308.

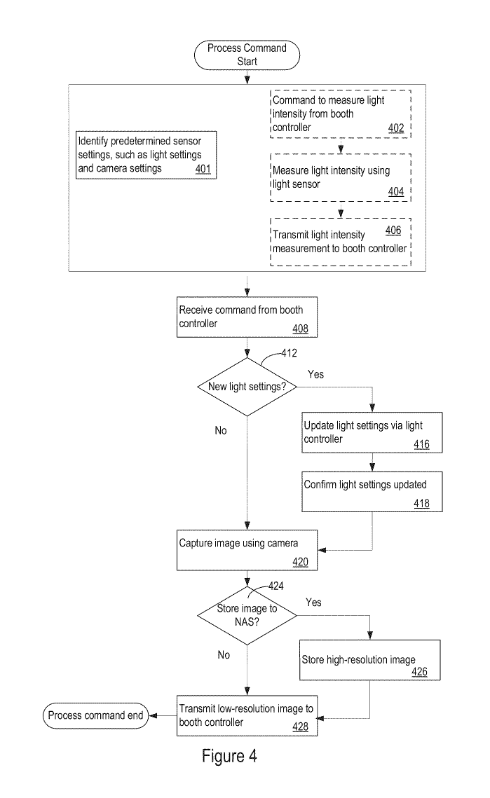

FIG. 4 shows example logic implemented by an example sensor system, such as sensor system 300. For example, in an example, the system may identify predetermined settings for the sensor system 300 (401). The predetermined settings may be based on user-defined inputs such as size of a vehicle in the booth. For example, light settings may be based on a size of the vehicle being entered by an operator of the booth controller 130. In one implementation, the operator selects a size from a user interface, such as a compact size, sedan size, full-size size or any other indication of size of the vehicle. Thus, the system may preprogram the lights per shot based on size of the vehicle and orientation of the camera being used to capture the image in an enclosed and controlled environment within the booth 120. The predetermined settings may also include settings for other sensor systems equipped in the booth, such as a camera. The predetermined settings identified may be based on a controlled environment within the booth 120, such as a controlled, and hence known, ambient light intensity, sound level, and other conditions within the booth 120 that may affect the sensor systems in the booth 120.

Alternatively, or in addition, in an example, the sensor system 300 may receive a command from the booth controller 130 to actively monitor conditions in the booth 120 (402). The command may be to measure the light intensity at a particular orientation of the vehicle in the vehicle documentation booth 120. The light intensity may be metered, or measured by the camera sensor systems or by separate light sensor systems. The camera sensor systems may adjust shutter speeds based on measured light intensity. The particular orientation to measure light conditions may depend on the location of the sensor system 300. For instance, in case the sensor system is the front sensor system 140F, the connected light sensor 310 may be used to measure the intensity of light that may affect an image captured by the camera 312 connected to the sensor system 300. In response to the command, the light intensity information may be measured and communicated to the booth controller 130 (404, 406). Lighting the entire vehicle documentation booth 120 indiscriminately with static lighting is not conducive to good photography and other sensor measurements. Extra light causes glare on the vehicle and backlighting conditions. Thereby, the vehicle may not be seen as the subject of the image by being the brightest lighted subject in the image. This issue may be addressed by individual control of each light in the booth 120.

The booth controller 130 may in response transmit a second command to the sensor system 300 (408). The second command may be to capture an image of the vehicle. However, based on the measured, and/or known light intensity, the booth controller 130 may command the sensor system 300 to update the light settings to a set of light setting values provided as part of the second command. The new light settings may be provided to adjust the light intensity at the particular orientation of the vehicle and the camera 312 so as to minimize image artifacts such as reflection, bright spots, and any other such image artifacts. In case new light settings are detected (412) in the received second command, the sensor system 300 may in turn command the light controller to adjust intensity of one or more lights 160 located within the vehicle documentation booth 120 (416). The update light settings may be confirmed (418). For example, in case the booth 120 is equipped with a light sensor system, the light intensity may be measured to determine if the lights have been adjusted as per the specified settings.

Upon confirmation of the light settings, the camera sensors may be instructed or requested via the booth controller 130 to capture an image of the vehicle within the booth 120. In an example, the booth controller may send a web service request to the camera sensor system, which may be a webserver, to receive an image. In response, the camera sensor system may capture an image of the vehicle (420). The camera sensor system may be sent a set of predetermined settings such as digital zoom setting, shutter speed setting, or any other setting which may be one of the predetermined settings. The camera sensor system may provide a low resolution version of the captured image to the booth controller 130 (428). Further, the booth controller 130 may send an instruction to the camera sensor system to store the captured image (424). The low resolution image may be reviewed at the booth controller 130 to determine whether the image should be stored. The image may be reviewed manually such as by an operator of the booth controller 130. Alternatively, or in addition, the image may be reviewed automatically for settings such as brightness, contrast, or any other image settings such as by using histogram analysis, or other image processing techniques. In response to the command from the booth controller 130, a high resolution image may be stored in the NAS 108 (426).

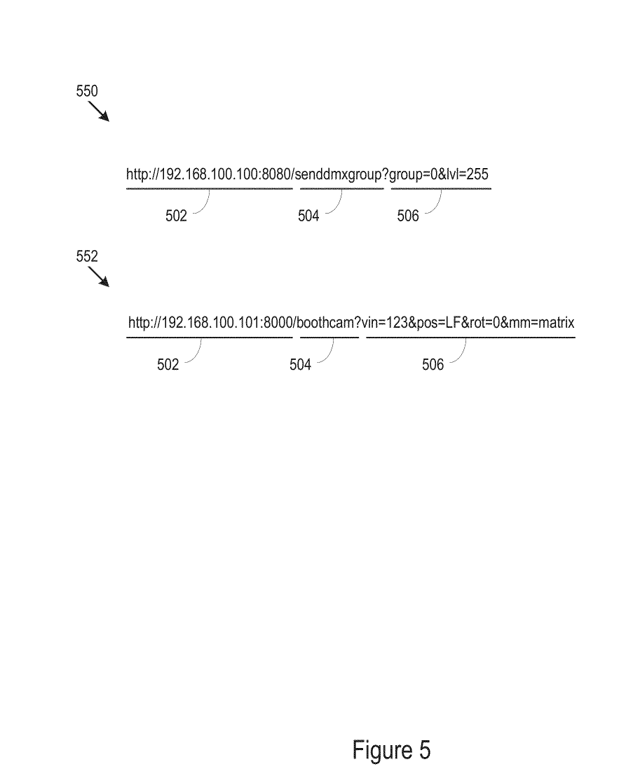

FIG. 5 shows example commands transmitted in an example vehicle documentation system. As will be evident by description throughout the document, the booth controller 130 may be a mobile device in communication with the components of the vehicle documentation system via a wireless medium. The booth controller 130 effectively communicates control information to sensor systems and in response receives the resulting measurements. For example, in case of the camera sensor systems, the booth controller 130 may execute an HTML document which in turn may request an image from a camera sensor system prompting the camera sensor system to acquire an image. The acquired image may be stored at a resolution the image is captured in and a lower resolution thumbnail image may be transmitted to the booth controller 130. Therefore, lower bandwidth may be required, permitting use of the wireless communication.

The command may be generated by the controller device 130, such as command 550. A command may include a unique identifier 502 of the destination device, such as a uniform resource locator (URL), or an Internet Protocol (IP) address and a port address, so that the command is routed to the intended device. For example, the command 550 indicates the IP address and port of the light controller 150 (see FIG. 1) while the command 552 is intended for the sensor system 140L1 (see FIG. 1). The command may further include a function 504 to be executed by the destination device. The function 504 may be part of an Application Programming Interface (API) provided by the destination device. Alternatively, the function 504 may be a custom function programmed for execution by the destination device. Example commands may further include a set of parameters 506 to be used during the execution of the function 504. The parameters 506 may be used for various purposes. For example, the parameters may indicate new setting values. Alternatively, or in addition, the parameters may provide information, such as filenames, date, time or any other information to be used by the destination device when storing results of the operation. The parameters 506 may further indicate information to annotate the results of the operation. Further yet, the parameters 506 may identify devices to which the command is to be relayed to.

The commands 550 and 552 are explained in detail further. The command 550 is a command intended for the light controller 150 as indicated by the IP address 502 (see FIG. 1). The function 504 of the command 550 indicates a function to set a light intensity values of lights in a predetermined group, group #0. Such commands facilitate fine turning of the indicated light for each shot providing better images and reduced glare from unneeded, extra light. The light intensity may be adjusted by configuring individual lights or a predetermined group of lights. The group of lights may be defined and adjusted for an image to be captured by a particular sensor system. For example, when capturing an image using the camera 312 of the sensor system 140F which is facing the front of the vehicle, the lights 160a facing that direction may be set to lower intensity and the lights in another direction, such as the lights 160b and 160d facing the vehicle from the left and right sides respectively may be set at a high intensity and the lights 160c facing the rear may be set at a medium intensity. The light intensities may be decided based on the measurement from the light sensor which may indicate ambient light in the vehicle documentation boot 120. Further, lights within each of those groups may be set to different intensities, so as to have a particular light intensity from the group as a whole. It will be understood that other configurations of light groups and intensities of the lights may be possible. In the example command 550, the group 0 as a whole is set to an intensity level 255.

The example command 552 is a command intended for the sensor system 140L1 as indicated by the IP address 502. (See FIG. 1). The function 504 of the command 552 indicates an adjustment being made to a camera in the booth. The parameters 506 in this case provide the camera to be adjusted (pos=LF), positioning and orientation of the camera (rot=0), and the light settings to use for this camera (mm=matrix). While two exemplary commands are illustrated, it will be understood that various other commands are possible. Table 1 below provides additional example parameters that may be provided.

TABLE 1
Meter Mode to change by camera location for lights.

| ‘spot’, | //img0 All Lights Off | |
|---|---|---|
| ‘spot’, | //img1 Front Lights On | |
| ‘spot’, | //img2. Left Lights On | |
| ‘matrix’, | //img3 Left Front Camera | |
| ‘matrix’, | //img4 Left Front Wheel Camera | |
| ‘spot’, | //img5 Rear Lights On | |
| ‘spot’, | //img6 Front Lights Off | |
| ‘matrix’, | //img7 Left Rear Wheel Camera | |
| ‘matrix’, | //img8 Left Rear Camera | |
| ‘spot’, | //img9 Left Lights Off | |
| ‘spot’, | //img10 | Rear Half Lights On |
| ‘spot’, | //img11 | Rear Camera |
| ‘spot’, | //img12 | Rear Half Lights Off |
| ‘spot’, | //img13 | Rear Lights On |
| ‘spot’, | //img14 | Right Lights On |
| ‘matrix’, | //img15 | Right Rear Camera |
| ‘matrix’, | //img16 | Right Rear Wheel Camera |
| ‘spot’, | //img17 | Front Lights On |
| ‘spot’, | //img18 Rear Lights Off | |
| ‘matrix’, | //img19 | Right Front Wheel Camera |
| ‘matrix’, | //img20 | Right Front Camera |
| ‘spot’, | //img21 | Left Lights Off |
| ‘spot’, | //img22 | Front Halt Lights On |
| ‘matrix’, | //img23 | Front Camera |
| ‘spot’, | //img24 | All Lights On |
| ‘spot’]; | //img25 | Top Camera |

Table 2 below provides example settings of groups of lights corresponding to particular image orientations.

TABLE 2

| var camHosts = [ | | |
|---|---|---|
| ‘DMX’, | //img0 | All Lights Off |
| ‘DMX’, | //img1 | Front Lights Or |
| ‘DMX’, | //img2 | Left Lights On |
| ‘192.168.100.101:8000’, | //img3 | Left Front Camera |
| ‘192.168.100.102:8000’, | //img4 | Left Front Wheel Camera |
| ‘DMX’, | //img5 | Rear Lights On |
| ‘DMX’, | //img6 | Front Lights Off |
| ‘192.168.100.103:8000’, | //img7 | Left Rear Wheel Camera |
| ‘192.168.100.104:8000’, | //img8 | Left Rear Camera |
| ‘DMX’, | //img9 | Left Lights Off |
| ‘DMX’, | //img10 | Rear Half Lights On |
| ‘192.168.100.105:8000’, | //img11 | Rear Camera |
| ‘DMX’, | //img12 | Rear Half Lights Off |
| ‘DMX’, | //img13 | Rear Lights On |
| ‘DMX’, | //img14 | Right Lights On |
| ‘192.168.100.106:8000’, | //img15 | Right Rear Camera |
| ‘192.168.100.107:8000’, | //img16 | Right Rear Wheel Camera |
| ‘DMX’, | //img17 | Front Lights On |
| ‘DMX’, | //img18 | Rear Lights Off |
| ‘192.168.100.108:8000’, | //img19 | Right Front Wheel Camera |
| ‘192.168.100.109:8000’, | //img20 | Right Front Camera |
| ‘DMX’, | //img21 | Right Lights Off |
| ‘DMX’, | //img22 | Front Half Lights On |
| ‘192.168.100.110:8000’, | //img23 | Front Camera |
| ‘DMX’, | //img24 | All Lights On |
| ‘192.168.100.111:8000’]; | //img25 | Top Camera |

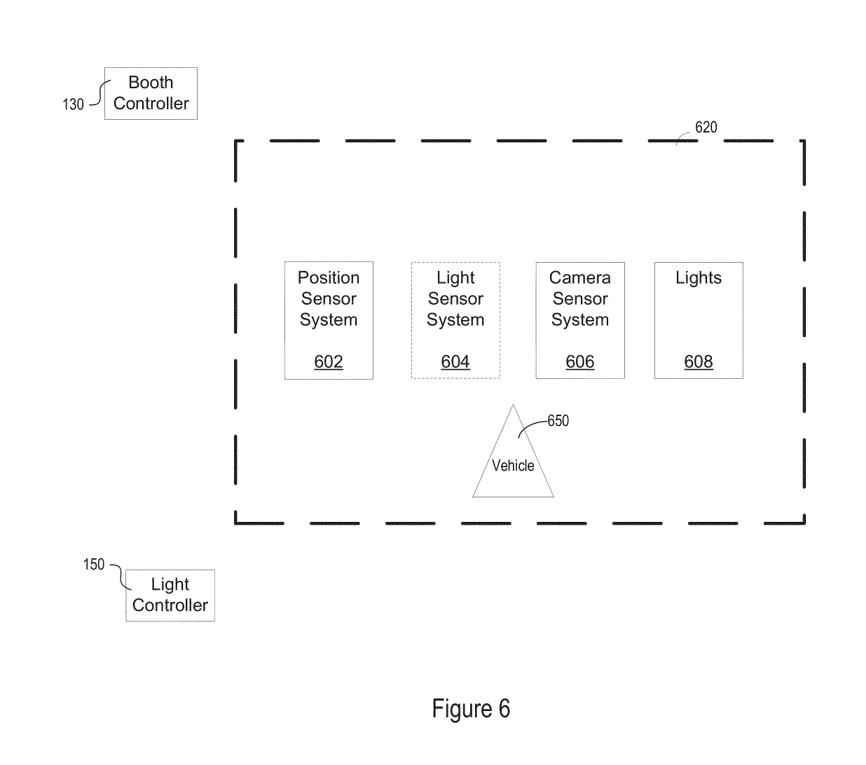

In another example, the controller device 130 may command various different sensor systems to generate documentation for a vehicle in the vehicle documentation booth 120. FIG. 6 shows an example vehicle documentation booth 620. The vehicle documentation booth 620 includes various sensor systems such as position sensor system 602, light sensor system 604, camera sensor system 606. The vehicle documentation booth 620 may include additional sensor systems, such as microphones, vibration sensors, temperature sensors, ultrasonic sensors and other measuring devices. The vehicle documentation booth 620 further may include lights 608, controllable via the light controller 150. The booth controller 130 may manage operations of the various sensor systems and lights to generate documentation of a vehicle 650 positioned within the vehicle documentation booth 620.

The various sensor systems may include circuitry similar to that described with respect to the sensor system 300. The sensor systems may be webservers that receive a command or request from the booth controller 130. In response, the sensor systems may capture information via the sensors equipped on the sensor systems and transmit the captured information to the booth controller 130. The different sensor systems may be equipped with different sensors to capture information. Alternatively, the sensor systems may all be equipped with a set of sensors out of which a subset is utilized. For example, the position sensor system 602 may be equipped or may use position sensors. The position sensors may use infrared, ultrasonic, weight, temperature or other such physical characteristics to determine position of the vehicle 650. The light sensor system 604 may be equipped with or may use light sensors that measure intensity of light within the vehicle documentation booth 620. The light intensity measured may be the ambient light in the vehicle documentation booth 620.

The camera sensor system 606 may be equipped with a still image or a video capture camera. The camera may be adjusted by the booth controller 130 and/or the camera sensor system 606. For example, the camera may be adjusted to zoom-in or zoom-out. The zooming may be a digital zoom (sometimes referred to as solid state zoom), or an optical zoom, or a combination of both.

For example, the region of an image sensor of the camera sensor system 606 used to capture the vehicle may be adjusted based on the size of the vehicle 650. For example, in case the vehicle 650 is a small vehicle, a smaller region of the image sensor may be utilized to capture the image of the vehicle 650, while a larger region of the image sensor may be used in case the vehicle 650 is a large vehicle. The size of the vehicle 650 may be specified by an operator of the booth controller 130, or may be determined based on information, such as that obtained from a vehicle information database, given inputs (e.g., a VIN), for example, that identify the make/model of the vehicle 650. For example, if the vehicle is identified as a sedan, the system may identify the vehicle as medium sized, while in case the vehicle is identified as a minivan or SUV, the vehicle may be considered large sized. The amount of the image sensor used to obtain the vehicle image may then vary according to the determined vehicle size, with larger vehicles using larger extents of the image sensor.

Additionally, or alternatively, the camera may be adjusted to pan in specific direction. A flash function on the camera may also be adjusted. Further, the camera may be adjusted to change lens exposure level, shutter speed, and any other such settings.

The booth controller 130 may also adjust the lights 608 by altering the intensity settings, such as to dim or brighten the lights. The light controller 150 may also be a webserver able to receive commands from the booth controller or the sensor systems. The commands to the light controller may indicate adjustment to be made to the lights 608, such as turning a light, or a group of lights on or off, or adjusting brightness of a light or a group of lights, or flashing the lights on and off.

The lights 608 may be divided into various groups. An individual light may be part of one or more groups. Each light may be assigned a unique identifier. Further, each group may also be assigned a unique identifier. The booth controller 130 or the sensor systems may provide settings to be applied to a light or a group of lights by indicating the corresponding identifier and the settings to be applied, such as in command 550 of FIG. 5. The groups of lights may be defined such that each group of lights is used when capturing information from a particular orientation.

The vehicle 650 may be an automobile, such as a car, sports utility vehicle (SUV), mini-van, truck, motorcycle, or any other automobile. The vehicle 650 may also be a boat, an airplane, or any other vehicle. The booth controller 130 may identify the vehicle based on an identifier of the vehicle, such as the VIN. The booth controller 130 may request information of the vehicle from a database. The database may be in the NAS 108, or on a server that is part of the network 102. The database may provide information such as vehicle make, model, year of manufacture, history of sales, odometer reading, interior conditioning, and any other details of the vehicle. The details may also provide whether the vehicle has air conditioning, leather seats, navigation, and/or other features of the vehicle.

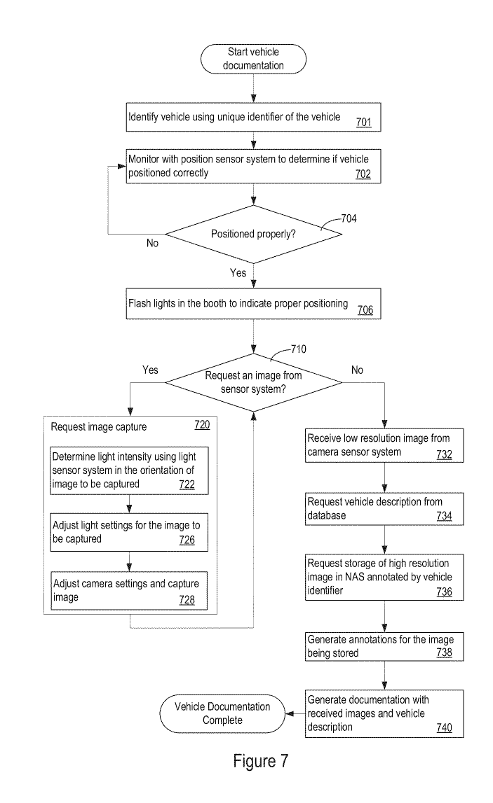

FIG. 7 shows an example vehicle documentation generation method. The method may be performed by the booth controller 130. The booth controller 130 may identify the vehicle based on the vehicle identifier (701). The vehicle identifier may be manually entered by an operator. Alternatively, the vehicle identifier may be scanned using a scanner, such as a barcode scanner, or a camera. The scanner may be equipped on the booth controller 130. The vehicle identity may indicate a size of the vehicle. For example, the size may be provided as length, width, and height dimensions of the vehicle. Alternatively, the size may be provided as a size-category, such as a small, medium, large, extra-large. In another example, the size may be provided as a category of the vehicle itself, such as a compact, sedan, mid-size, full-size, SUV, cross-over, truck, or other such vehicle category.

Based on the identified size of the vehicle 650, the booth controller 130 may determine a position within the booth 620 at which the vehicle 650 should be placed to capture other information of the vehicle, such as images of the vehicle. Since, the camera sensor system 606 may be in a fixed position within the booth 120, and the vehicle 650 is movable, depending on where the vehicle 650 is positioned it may or may not be aligned in the image. So an accurate method of feedback to an operator positioning the vehicle 650 may be provided to stop the car in the right position. The booth controller 130 may monitor the position of the vehicle 650 within the vehicle documentation booth 620 (702). The booth controller 130 may continuously receive position information of the vehicle from the position sensor system 602 for such monitoring. The position information may be received in response to the booth controller 130 requesting such information from the position sensor system 602. The booth controller 130 may compare the received position information with the determined position where the vehicle 650 is to be placed (704). The vehicle 650 may be moved until the vehicle 650 is placed in the determined position. Once the vehicle 650 is substantially in the determined position, the booth controller 130 may provide an indication of the position. For example, the booth controller 130 may send commands for the light controller 150 to flash some or all of the lights 608 within the booth 620 (706).

The booth controller 130 may then determine what information of the vehicle 650 is to be captured using the various sensor systems within the booth 620. For example, images of the vehicle 650 from various angles may be captured to further document the vehicle 650. Such information may be used to generate vehicle documentation that may be useful for sharing with potential bidders or customers who may be interested in purchasing the vehicle 650. If an image is required, a request to capture the image from the particular viewpoint may be sent to the camera sensor system 606 (710, 720). Capturing the image may involve various steps in itself (720). For example, initially, intensity or brightness of the ambient light in the booth 620 may be determined (722). The ambient light may be measured for capturing the image from a particular vantage point, or angle, or orientation of the vehicle 650 (722). For example, a front view of the vehicle 650 may be captured. The front view may be captured with or without the vehicle hood opened. Other angles and orientations may be possible such as a side view from the driver's side or from the passenger's side; rear view; top view; interior view; or any other view of the vehicle to illustrate features of the vehicle to the potential bidders or customers.

The booth controller 130 may determine optimal light intensity or brightness to capture a presentable image of the vehicle 650 from the particular vantage point. The actual light intensity may be measured using the light sensor system 604 (722). The actual light intensity may be compared with the calculated optimal light intensity and accordingly, settings for the lights 608 may be calculated. The calculated settings may be applied to the lights 608 so that the optimal light intensity is achieved in the booth 620 (726). The calculated settings may be applied using the light controller 150. The booth controller 130 or the camera sensor system 606 may be responsible for calculate the updated settings and request the light controller 150 to apply the updated settings. As described throughout the document, the light settings may involve updating individual lights or group of lights.

Further, the booth controller 130 may determine settings of the camera sensor system from the particular vantage point from which an image is to be captured based on the vehicle size, the light intensity, and other parameters (726). Once the light settings and camera settings are updated, the camera sensor system 606 may capture an image of the vehicle 650 from the specified vantage point (728). The booth controller 130 may send a request to the camera sensor system 606 to capture the image once the settings have been updated. Further, the booth controller 130 may send multiple requests to the camera sensor system 606 to capture multiple images from the particular vantage point. The multiple images may be captured using the different combinations of the light and/or camera settings. For example, multiple images from the particular vantage point with same light settings but different camera settings may be captured. For instance, an image from the camera sensor system 606 positioned close to the left front of the vehicle 650 may be used to capture an image of the entire vehicle 650 as well as an image that provides details of the left front tire of the vehicle 650. Alternatively, or in addition, the light settings may also be changed for the two images captured. Images other than those described as examples in this document may be captured.

The fixed camera sensors system 606 in the vehicle documentation booth 120 may capture exterior images of the vehicle 650. Interior shots of the vehicle 650 may be captured by using the booth controller 130, which is a mobile device. The booth controller 130 may be equipped with an onboard camera that may be controlled by an application interfaced with the vehicle documentation generation system. The interior images may be captured as part of the workflow of controlling the documentation booth 120 (728). The interior images may then be integrated into the set of images captured from the camera sensor system 606.

The image captured by the camera sensor system 606 may be stored at a resolution at which the image is captured, such as 2 Mega Pixel (MP), 5 MP, 13 MP, or any other resolution the camera may be set for. However, the image may be converted to a lower resolution image, such as a thumbnail image, or 640×480, or any other resolution. The lower resolution image may be forwarded to the booth controller 130. The booth controller 130 may receive and display the lower resolution image (732). An operator may view the displayed lower resolution image and determine whether the image needs to be retaken. For example, the image may be too noisy, or there may be a reflection, or the image may be distorted. If the image is retaken, the earlier image may be replaced by the retaken image. Alternatively, the retaken image may be stored in addition to the earlier image.

Information of the vehicle 650 may be requested from the database (734). The information may be requested using the unique identifier of the vehicle 650. The information received in response may be used to annotate the image when stored and/or when generating the documentation for the vehicle 650.

In case the image is acceptable, the booth controller 130 may request the camera sensor system 606 to store the image (736). For example, the booth controller 130 may display various user interface elements, such as an archival directive element. The operator may interact with the user interface elements to send requests to the sensor systems and/or light controller 150. For example, the archival directive element may send a request to the camera sensor system 606 to store the image at a high resolution, such as the resolution at which the image was taken. Alternatively, the booth controller 130 may send a command that indicates a resolution at which the image is to be stored. The resolution may be one of the parameters in the command sent, such as the commands 550 and 552. Alternatively, the resolution may be a predetermined resolution that has been communicated to the camera system 606 previously. Alternatively, or in addition, the command or request sent by the booth controller 130 may contain a destination to store the image. The destination may be the NAS 108. The destination may further specify details such as a folder within the NAS 108. Thus, the captured image may be stored in the specified destination without being first transferred to the booth controller 130.

Further yet, the command or request may include other parameters to indicate annotations for the image being stored, such as the unique identifier of the vehicle 650 to be included in the filename or as a tag at the time the image is stored (738). The camera sensor system 606 may include further annotations to the filename or as tags to the image. For example, the camera sensor system 606 may include orientation, such as ‘left front’ or ‘left front tire’, when storing the image. Other annotations may also be possible, such as the settings applied to the camera sensor system and the light settings used when capturing the image. Additionally, the information obtained from the database, indicating features and other information of the vehicle 650 may be used as annotations.

The captured images and the information received from the database may be put together to generate documentation of the vehicle 650. The documentation may be in form of a web-page, document, tabular display, worksheet, database table, or any other format. For example, a webpage, such as an Hyper Text Markup Language (HTML) page, may be generated with the images and the information rendered on the webpage. It is understood that HTML is just one possible example format and other formats such as Extensible Markup Language (XML), Portable Document Format (PDF), Open Document Format (ODF), or any other proprietary or non-proprietary formats may be used to generate the documentation. The generated documentation may be static or dynamic in nature. Static documentation is non-interactive, whereas dynamic documentation may be more interactive in nature. For example, the images displayed in the documentation may be thumbnail images, and when interacted with, such as by clicking, may display the corresponding higher resolution image. Alternatively, or in addition, the interaction may display vehicle details pertaining to the image that is being viewed in detail.

The generated documentation may be presented to the potential bidders and customers to review the vehicle information so as to determine whether to pursue a sale of the vehicle. The generated documentation may be integrated with a web-portal of a seller or auctioneer of the vehicle. Thus, upon entry of the vehicle into the vehicle documentation booth, with a few interactions with the booth controller, the seller or auctioneer, may be able to capture images of the vehicle from various angles and vantage points, link the images to the vehicle information in a database and generate documentation, such as a webpage, that may be presented to a potential purchaser as marketing material with the vehicle images and information. The vehicle documentation system described may thus enable or enhance efficiency of operation of a seller or auctioneer, such as a vehicle dealer or auctioneer.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A vehicle documentation booth comprising:
a structure adapted to receive a vehicle;
multiple sensor systems distributed within the structure, where at least some of the sensor systems each comprise:
a communication interface assigned a specific address;
a sensor interface configured to communicate with a vehicle sensor; and
request processing circuitry in communication with the communication interface, the request processing circuitry configured to:
implement a web service request/response protocol;
receive a web server vehicle documentation request on the communication interface from a requesting system;
parse the web server vehicle documentation request to obtain a vehicle sensor control command;
execute the vehicle sensor control command on the vehicle sensor;
obtain a sensor result from the vehicle sensor responsive to the vehicle sensor control command; and
create a response message compliant with the web service request/response protocol and comprising the sensor result; and
return the response message to the requesting system.

2. The vehicle documentation booth of claim 1, where the sensor interface comprises a light sensor interface; and where:
the vehicle documentation request comprises a lighting intensity measurement request.

3. The vehicle documentation booth of claim 1, where the sensor interface comprises a lighting interface configured to control an illumination source; and where:
the vehicle documentation request comprises a lighting control command that specifies an output intensity for the illumination source.

4. The vehicle documentation booth of claim 3, where:
the vehicle sensor comprises a camera; and
the illumination source is positioned to provide lighting for the camera.

5. The vehicle documentation booth of claim 1, where:
the vehicle sensor comprises a camera; and
at least some of the sensor systems each further comprise:
a lighting interface configured to control multiple individual illumination sources positioned together as a group to provide lighting for the camera; and where:
the vehicle documentation request comprises a lighting control command that specifies an output intensity for multiple of the individual illumination sources.

6. The vehicle documentation booth of claim 1, where:
the vehicle sensor comprises a camera configured to capture a first image at a specific resolution; and
the request processing circuitry is further configured to:
generate a second image from the first image, the second image a lower resolution version of the first image; and
return the second image as the sensor result to the requesting system.

7. The vehicle documentation booth of claim 6, where the request processing circuitry is further configured to:
communicate the first image to an image repository.

8. The vehicle documentation booth of claim 7, where the request processing circuitry is further configured to communicate the first image after returning the second image to the requesting system and receiving an archival command from the requesting system.

9. The vehicle documentation booth of claim 1, where web server vehicle documentation request comprises a uniform resource locator comprising the vehicle sensor control command.

10. The vehicle documentation booth of claim 9, where the uniform resource locator comprises the specific address, and a vehicle sensor specifier.

11. A vehicle documentation method comprising:
in a structure adapted to receive a vehicle:
executing multiple sensor systems distributed within the structure, including:
receiving with a web service request/response protocol, from a requesting system, a web server vehicle documentation request over a communication interface assigned a specific address;
parsing the web server vehicle documentation request to obtain a vehicle sensor control command;
executing the vehicle sensor control command on a vehicle sensor;
obtaining a sensor result from the vehicle sensor responsive to the vehicle sensor control command;
creating a response message compliant with the web service request/response protocol and comprising the sensor result; and
returning the response message to the requesting system.

12. The method of claim 11, where executing comprises:
executing a lighting intensity measurement request.

13. The method of claim 11, where executing comprises:
executing an illumination output intensity control command.

14. The method of claim 11, where executing comprises:
executing an illumination output intensity control command; and
executing an image capture command for a camera positioned to obtain illumination responsive to the illumination output intensity control command.

15. The method of claim 11, where executing comprises:
executing multiple illumination output intensity control commands for individual illumination sources positioned together as a group to provide lighting for the vehicle sensor.

16. A vehicle photobooth controller comprising:
a communication interface configured to send and receive web service request/response protocol compliant messages; and
request processing circuitry in communication with the communication interface, the request processing circuitry configured to:
determine a vehicle sensor system address for a vehicle sensor system positioned within a vehicle documentation booth;
create a web server vehicle documentation request;
send the web server vehicle documentation request over the communication interface to the vehicle sensor system;
receive a response message compliant with the web service request/response protocol, the response message comprising a sensor result responsive to the web server vehicle documentation request; and
display the sensor result for review on a user interface.

17. The vehicle photobooth controller of claim 16, where the user interface comprises:
an archival directive interface element; and where the processing circuitry is further configured to:
send a sensor data archival command over the communication interface to the vehicle sensor system.

18. The vehicle photobooth controller of claim 16, where:
the request processing circuitry is further configured to send a light intensity sensor request to the vehicle sensor system to determine light intensity within the vehicle documentation booth.

19. The vehicle photobooth controller of claim 16, where:
the request processing circuitry is further configured to send a light setting request to the vehicle sensor system, the light setting request comprising lighting intensity specifiers for multiple different lights in the vehicle documentation booth.

20. The vehicle photobooth controller of claim 16, where:
the web server vehicle documentation request comprises a uniform resource locator that specifies the vehicle sensor system address.
